(19) United States
(12) Patent Application Publication
(10) Pub. No.: US 2004/0139064 A1
(43) Pub. Date: Jul. 15, 2004

(54) Method for navigation by computation of groups, receiver for carrying out said method and graphical interface for presenting said method

(76) Inventors: Louis Chevallier, La Meziere (FR); Jiang Shao, Rennes (FR); Jean-Ronan Vigouroux, Rennes (FR)

Correspondence Address: Joseph S Tripoli, Thomas Licensing Inc, Patent Operations, CN 5312, Princeton, NJ, 08543-0028, US

(21) Appl. No.: 10/472,064

(22) PCT Filed: Mar. 15, 2002
(86) PCT No.: PCT/FR02/00921

(30) Foreign Application Priority Data
Mar. 16, 2001 (FR) 01/03576

(51) Int. Cl. G06F 7/00

(52) U.S. Cl. 707/3

(57) ABSTRACT

The present invention relates to a process for navigating around a set of multimedia documents with the aid of a user interface: the navigator. A current document is firstly selected. Next, the navigator utilizes the descriptive data related to the documents and determines groups of documents possessing descriptive data exhibiting similarities. The navigator presents on a screen the group containing all the documents including the current one and places the other groups as a function of their similarities with the current document. The user navigates by selecting one group then another, the navigator recalculates all the groups with each change of current document.

The invention also relates to a device able to execute a software navigation module, said module determines groups of documents, then displays them, thereby enabling the user to select them.

The invention also relates to a graphical interface making it possible to view multimedia documents.

The invention relates to a process for navigating among multimedia documents accessible with the help of a multimedia receiver, to a multimedia receiver equipped with a user interface and to a graphical interface. The invention applies in particular in the case where descriptive data associated with the multimedia documents are available.

A user interface uses these descriptive data to formulate menus which can be displayed on the screen of a television, thus enabling the user to choose the multimedia documents. Patent application FR96/09679 filed by the applicant describes a process for selecting television programs and a device incorporating a graphical interface enabling the user to navigate through lists of programs. The menus enable the user to ascertain the general content of an audiovisual transmission and thus to select the latter according to his tastes. The descriptive data, called “service information” in the standard relating to DVB-SI, are stored in a local database and constantly updated as a function of the documents accessible by the user. The elements of the database are grouped together according to certain criteria defined by the document provider and contained in the service information, such as: topic, language, rating level, etc.

With the growing number of audiovisual documents and broadcasting channels, the user can access a very large number of documents. Therefore, searching for documents with contemporary user interfaces may prove to be lengthy and onerous, since the user must search through a long list of documents. The size of the screen being limited the latter depicts only a part of this list, the user must therefore go from one screen page to another if he wishes to find the right document.

The introduction of digital network has seen the appearance of mass storage means, digital TV set top boxes also permitting access to Internet type networks in homes. Tomorrow's user will be faced with a very considerable quantity of multimedia documents of various types, such as audio, videos, pictures, text, application/services, etc. User interfaces must henceforth enable the user to navigate through such multimedia databases and to find the documents that the user desires, and to do so in an effective and user-friendly manner.

European patent application EP 1 024 437 describes a method for navigating among documents by grouping them into groups by “clustering” techniques. This application describes menus displaying groups of documents represented by textual information and calculated on the basis of a group of documents. This application describes fairly complex navigation from one document to another and offers few navigation aids.

The invention proposes a new dynamic navigation user interface concept which offers navigation and more effective and user-friendly possibilities of searching for multimedia documents.

A subject of the invention is a process for navigating among a set of multimedia documents in a receiver equipped with a display device, the multimedia documents are associated with descriptive data comprising classification elements for indexing the documents, the process is characterized in that it comprises the following consecutive steps:

a) determination of a work set among the set of multimedia documents, the documents of this work set possessing at least one characteristic in common with a current document;

b) determination of a plurality of groups among the work set, containing documents whose classification elements exhibit similarities;

c) calculation for each group of values expressing the similarity between the classification elements of a current document chosen by the user and the classification elements of the documents contained in each group;

d) display of the elements of the current group containing the current document and of at least one identifier of another group possessing the highest similarity value calculated in step c);

e) reception of a navigation command for changing current document (3.9) triggering a new execution of steps a), b), c) and d).

In this way, the process makes it possible to formulate a new navigation structure following a command performed by the user. The navigator displays groups of documents on the screen in such a way that the user can either change documents and in this case see the groups of documents close to this new document, or navigate among these groups. Navigation is thus aided by the fact that the display proposes at one and the same time documents that are close to the current document, and groups of documents having similarities with the current document.

According to an improvement, the process comprises a step of filtering the accessible documents, the documents thus filtered possessing at least one characteristic in common with the current document. Thus, the step of determining the groups takes into account only a limited number of documents, thereby making it possible to accelerate the processing. The number of filtered documents is preferably determined.

According to another improvement, the number of documents in each group is less than a value determined in advance.

According to another improvement, the process comprises a step of formulating identifiers of each group, the display step exhibiting all the documents of the group containing the current document, and the other groups by their identifiers. Thus, the user can easily choose a document from the current group and ascertain the subject matter of the other groups. According to another improvement, the group identifier is the title of the document most representative of the group. A variant consists in the identifier being calculated on the basis of the classification elements of all the documents of the group.

According to another improvement, the process comprises a step of correspondence between words extracted from the descriptive data and at least one subject matter. This step makes it possible to replace the data descriptive of the provider of events with a subject matter with the help of a table whose contents are specific to each receiver.

According to another improvement, the request making it possible to formulate the various groups of documents takes into account the profile of the user. In this way, the documents proposed in the course of navigation are better tailored to the user.

A subject of the invention is also a multimedia receiver comprising a central unit, a means of receiving multimedia documents and descriptive data, said descriptive data containing classification elements for indexing the documents according to categories, a means of entering a user command for selecting a current document, characterized in that it comprises: a means of determining a plurality of groups of documents whose classification elements exhibit similarities, a means of calculating the values representing the similarity between the classification elements of the current document and the set of classification elements of the documents constituting each group, a means of displaying a representation of the current group containing the identifiers of the documents of the group and a representation of at least one other group having the largest similarity value, a means of navigation making it possible to select another current document and activating the means of determination, the means of calculation, and the means of display so as to bring into view groups other than previously determined on the basis of the new current document.

According to a first improvement, the receiver is furnished with a means of filtering the documents making it possible to retain only a set of documents possessing at least one descriptive data item in common with the current document. According to another improvement, the number of filtered documents is predetermined.

According to another improvement, the receiver comprises a means of determining the identifiers of each group, these identifiers being determined on the basis of part at least of the descriptive data of the documents of the group and displayed in proximity to the representation of the groups thus identified.

According to another improvement, the identifier of each group is the title of the document most representative of the group. A variant of this improvement consists in the identifier being calculated on the basis of part at least of the classification elements of all the documents of the group.

According to another improvement, the receiver is furnished with a means of correspondence between at least one word extracted from the descriptive data and at least one subject matter. In this way, the receiver replaces descriptive data with subject matters extracted from the memory of the receiver.

According to another improvement, the receiver is furnished with a means of storing a profile of the user. The means of calculating the similarity values taking into account the profile of the user, the groups are better tailored to the user's tastes.

A subject of the invention is also a graphical interface for the selection and the presentation of audiovisual transmissions, characterized in that it comprises a plurality of closed and identifiable graphical shapes, each graphical shape representing a group of elements and containing a list of identifiers of elements possessing at least one common characteristic from a set of characteristics, a so-called “central” graphical shape containing a so-called “current” element, both being highlighted, the distance between each graphical shape and the central graphical shape being inversely proportional to the degree of similarity between the characteristics of the elements of the group and the characteristics of the current element.

According to an improvement, the size of the graphical shapes is proportional to the degree of similarity between the characteristics of the elements of the group and the characteristics of the current element.

According to another improvement, the graphical shapes constitute an open ellipse. According to another improvement, the central graphical shape exhibits the list of the identifiers of all its elements.

Other characteristics and advantages of the invention will now become apparent with greater detail within the framework of the description which follows of exemplary embodiments given by way of illustration while referring to the appended figures which represent:

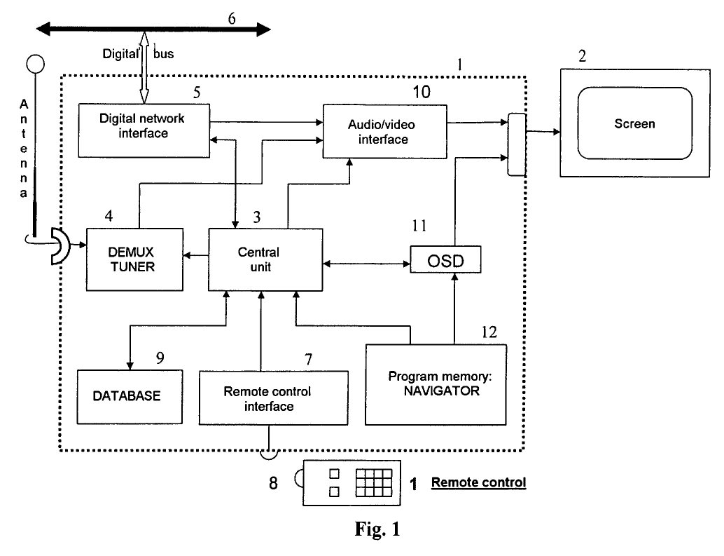

FIG. 1 is a block diagram of a multimedia receiver for the implementation of the invention,

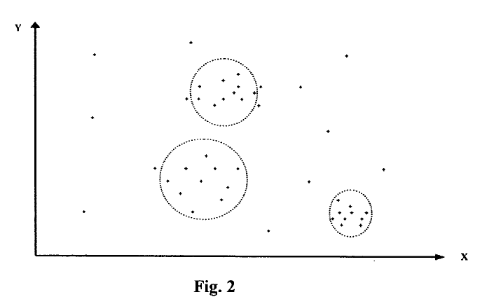

FIG. 2 is a graph for the representation of the documents according to a grouping calculation,

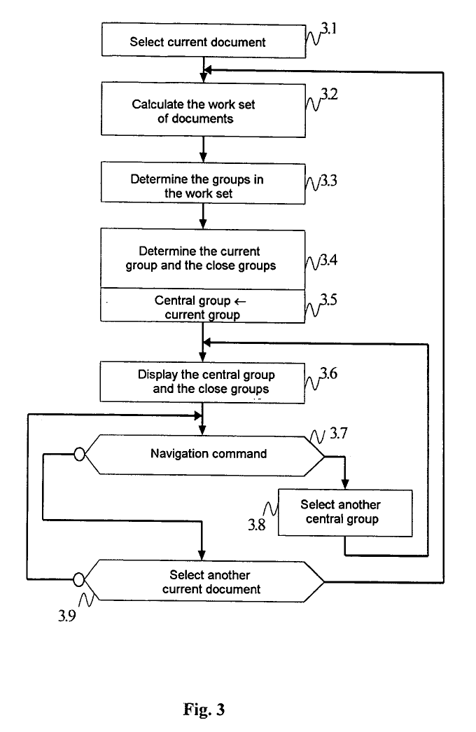

FIG. 3 is a flowchart of the main steps performed by the navigator,

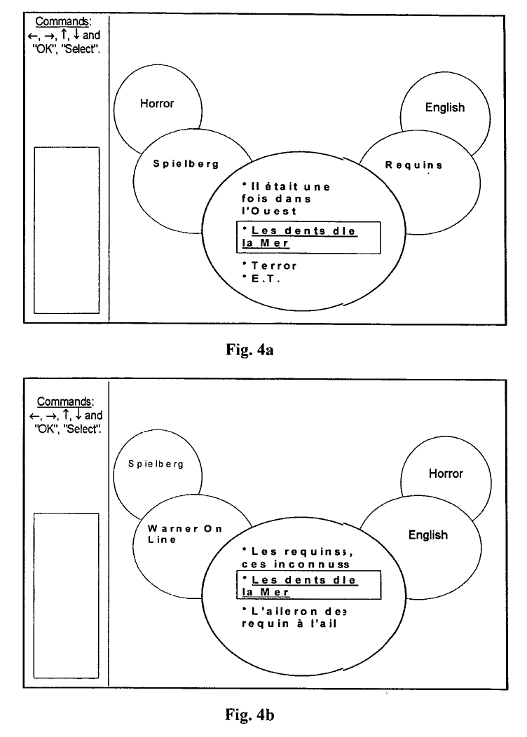

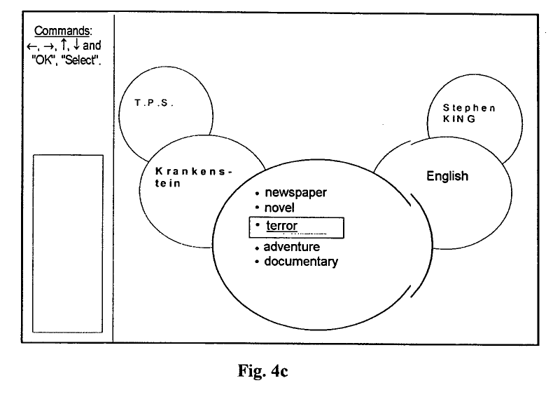

FIGS. 4a, 4b, 4c are diagrams of screenshots generated by the navigator,

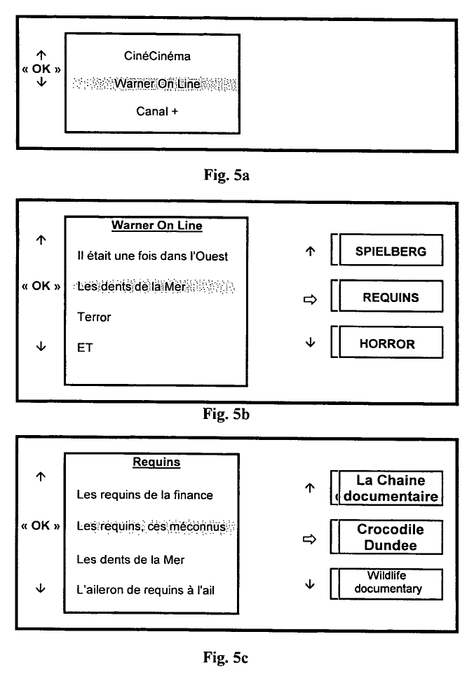

FIGS. 5a, 5b, 5c are other examples of screenshots generated by the navigator.

The manner of operation of a multimedia receiver 1 equipped with a display device 2 will firstly be described. The receiver comprises a central unit 3 linked to a program memory 12, and an interface 5 for communication with a high bit rate local digital bus 6 making it possible to transmit audio/video data in real time. This network is for example an IEEE 1394 network. The receiver can also receive audio/video data from a broadcasting network through a reception antenna associated with a demodulator 4. The receiver furthermore comprises an infrared signal receiver 7 for receiving the signals from a remote control 8, a memory 9 for storing a database, and audio/video decoding logic 10 for creating audiovisual signals sent to the television screen 2. The remote control is furnished with direction keys ↑, ↓, → and ← and keys: “OK” and “Select” the function of which we shall see later.

The receiver also comprises a circuit 11 for displaying data on the screen, often called the OSD circuit, the initials standing for “On Screen Display”. The OSD circuit 11 is a text and graphics generator which enables menus and pictograms (for example, a number corresponding to the station displayed) to be displayed on the screen and which enables the navigation menus in accordance with the present invention to be displayed. The OSD circuit is controlled by the Central Unit 3 and a navigator 12. The navigator 12 is advantageously made in the form of a program module recorded in a read only memory. It may also be embodied in the form of a custom circuit of ASIC type for example.

The digital bus 6 and/or the broadcasting network sends the receiver data comprising multimedia documents and descriptive data pertaining to these documents. These data originate either from a broadcasting network, or from the digital network 6. The descriptive data comprise classification elements also called “attributes”, for the accessible multimedia documents. The descriptive data are for example contained in the service information specified in the DVB-SI Standard. These data are stored in the database of the memory 9 of the receiver and are continuously updated. The navigator thereafter extracts the information from this database and processes it to produce the navigation menus displayed on the screen.

In the exemplary embodiment which follows, the navigator takes into account five types of attributes contained in the descriptive data: language, topic, sub-topic, source and producer. Here are examples of attributes fixed by the document provider for classifying the available documents:

Language: English, French, German, Italian, Arabic, others;

Topic: film, information, documentary, sport, game/show;

Sub-topic:

film: {adventure, drama, erotic, detective story, fiction, others};

information: {news, radio, weather forecast, stock market, sport, other};

documentary: {general, nature, culture, social, history};

game/show: {general, variety, circus, talk show, circus};

sport: {general, football, tennis, basketball, athletics, water sports};

Source: TPS, Canal Satellite, home DVD, video recorder, Web.

Producer: Spielberg, Coppola, Besson, Kubrick, Truffaud.

The receiver also takes into account the title and the summary which are contained in identified fields of descriptive data. The title and the summary consist of character strings that can be processed digitally. For example, the title of the film “Les dents de la Mer” [“Jaws” in English] contains the significant words “dents” and “Mer”. The meaning of these words generally makes it possible to identify one or more subject matters dealt with in the document. The receiver filters the character strings, retaining only the significant words. The filtering is performed with the help of a list of words which possess a precise semantic content. If a word of the title or of the summary is present in the list, it is retained, otherwise it is not taken into account. The receiver associates a sixth type of attribute called “Title and summary” with the five previously cited to classify each document. According to the titles and the content of the summaries, the filtering makes it possible to extract one or more attributes as a function of a list specific to the receiver. It should be noted that such filtering may eliminate all the attributes, in this case this type of attribute is not taken into account.

An improvement consists in these words being substituted for subject matters by virtue of a dictionary. The subject matters of a document make it possible to classify a document with the help of predefined attributes specific to the receiver and which may be entered by the user. The subject matters differ from descriptive data such as the topic or sub-topic, the latter being defined by the broadcaster. The dictionary consists of a correspondence table which associates a subject matter or a list of subject matters with an attribute or a list of attributes. The table contains for example a list of 50000 current words, this list also makes it possible to perform the filtering function described previously. Such a list may contain words from various languages, and thus translate them into words understandable by the user. When a word from the title or from the summary of a document is in this list, the subject matters extracted from the dictionary are associated with this document instead of part of the attributes provided by the broadcaster. All the subject matters extracted from the dictionary on the basis of the content of the title and of the summary are grouped into one and the same list characterizing the documents at the level of the “title and summary” attribute type.

Let us now take the particularly simple case of a film title such as “Les dents de la Mer”. The dictionary associates with “dents” [teeth] the following subject matters: “anatomy”, “animals”, “horror”; and with “Mer” [Sea] the subject matters: “Sea”, “Voyage”, “boat”, “adventure”. The film “Les dents de la Mer” therefore has, for a given receiver, the following eight attributes: anatomy, animals, horror; Sea, Voyage, boat, adventure. Let us know assume that the summary of this film contains the words: beach, swimmer, boat, fisherman. The dictionary associates “Sea”, which is the common subject matter associated with the four words. One therefore sees that the use of the dictionary makes it possible to increase or to decrease the number of words associated with a document.

With the help of the attributes provided by the six classes of attributes, the receiver calculates a coordinate {X₁, X₂, X₃, X₄, X₅, X₆} in a multidimensional space. The number of dimensions of this space is that of the number of identifiable attributes. The coordinates are calculated by assigning numerical values to the attributes of the documents. On the basis of a set of documents and of their attributes, it is possible to plot a graph where each document is represented by a “document/point” whose coordinates are {X₁, X₂, . . . Xᵢ}. The technique of calculating the coordinates {X₁, X₂, . . . Xᵢ} is well known per se. American patent U.S. Pat. No. 5,835,087 filed by Messrs Herz, Eisner and Ungar shows such techniques. It will be seen subsequently that the calculation of the coordinates can take into account other parameters, such as a user profile or a current document. In a general manner, the coordinates {X₁, X₂, . . . Xᵢ} make it possible to represent the position of the documents/points graphically as a function of the similarity of their attributes. The greater the similarity between their attributes, the smaller the distances between the documents/points. The distance may be calculated in a Euclidian manner as being the sum of the squares of the differences in each dimension. The distance value is anyway inversely proportional to the degree of similarity of the attributes. FIG. 2 shows a graphical representation of a set of documents/points in the case where the calculation of the coordinates takes into account only two classes of attributes, it then being possible for the representation to be performed with the help of a plane. The distribution of all the documents/points is not generally very uniform, there are apparent in the graph groupings of documents/points that are fairly close together, also called “clusters”. One also finds isolated points. If a specified point is chosen in the graph, dubbed “central”, it is possible to calculate the distances between this central point and each document/points. By plotting a circle of radius r around this point, one determines a set of documents whose points are in the circle. Hence, these documents have relatively similar attributes, all the more so the smaller the radius r. If the central point is a document/point, this so-called “central” document possesses similar attributes to those of all the documents belonging to the circle.

On the basis of the set of documents/points illustrated by FIG. 2, the zones of greatest density and the centre of these zones are determined by calculation. One thus finds central points. In order for the groups to have an average size compatible with the display on a screen, the number of elements per group is limited: ten elements for example. The distances between the central point and each document/point are calculated, the groups are then formed with the ten elements closest to the central points. FIG. 2 shows three groups of documents/points circumscribed by circles of different sizes, each containing ten elements.

We shall now describe the manner in which the navigator operates. The main steps executed by the navigator are described by the flowchart of FIG. 3. On initiation (step 3.1), the navigator determines the current document. This document is for example the last document selected when the navigator was last turned off. If the navigator was used previously as electronic broadcast program guide, the current document on initiation is the event now being broadcast on the last service selected.

In step 3.2, the navigator reads all the accessible documents from the memory and determines a work set centred around the current document. This work set contains for example all the documents possessing at least two attributes in common with the current document. The work set makes it possible to limit the number of documents for which complex calculations will subsequently be performed. An improvement consists in calculating the number of attributes in common so as to obtain a predetermined number of documents in the work set. For example, the work set should contain around one hundred documents, this enabling the complex calculations which will subsequently be performed to be carried out in a reasonable time. If with two attributes in common, the work set contains three hundred documents, the navigator recalculates the entire set taking into account three attributes in common. As long as the number of documents is not close to the predetermined number, the navigator repeats the step, increasing by one unit the number of attributes in common.

In the course of step 3.3, the navigator defines groups by invoking the grouping technique described previously. The grouping is performed using the attributes of the documents of the work set, and takes no account of the current document. The criterion for formulating the groups is the number of elements, this number depends on the display capabilities. According to the present exemplary embodiment, the number of documents per group is fixed at four. It is very possible for one and the same point/document to belong to several groups, this document will then appear in several places.

In step 3.4, the navigator calculates the degree of similarity between each group and the group containing the current document, the latter being the “current group”. This calculation makes it possible to determine the groups that are close. The determination can be performed in various ways. A first manner consists in calculating the barycentre of the documents/points of each group determined in step 3.3, and in calculating the distances between the current document/point and each barycentre. The close groups are those for which the calculated distances are the closest. A second manner of proceeding consists in concatenating all the attributes of the documents of each group and in reckoning up the number of attributes identical to those of the current document. On completion of step 3.4, the navigator chooses a certain number of close groups, according to the present exemplary embodiment: four close groups. The fact that certain of these groups are closer than others will be taken into account at the display level.

Next, the navigator prepares the display, it chooses a central group which is the current group (step 3.5). Then, in step 3.6, the navigator displays on the screen the five groups. FIGS. 4a, 4b and 4c show examples of how the screen looks when it is controlled by the navigator. The groups of documents appear in round shapes, the five groups forming an open ellipse. The screen always displays the same predetermined number of groups, five according to the present example. The central group is in the foreground in the centre, the four close groups are on either side of the central group. All the documents of the central group are indicated by their titles, the current document is highlighted by underlining, emboldening, a special colour or flashing. The two groups in the background are regarded as not as close (according to the calculation performed in step 3.4) as the two groups in the midground, that is to say the documents that they contain have attributes that are less similar than the first two groups. The open character of the ellipse expresses the fact that groups other than the five represented exist but are not represented. In fact these no represented groups fit between the background group on the left and the background group on the right. The central group displays its elements, the other four groups which appear in the midground are only identified by a symbol and do not display their elements. This symbol may be a character string or a graphic. According to a first embodiment, the character string is the title of the document whose coordinates {X₁, X₂, . . . Xᵢ} in the group are closest to those of the central point of the group. According to a variant, the character string is formed by associating the most significant words and/or the words most often repeated in the attributes of the documents of the group considered.

As before, navigation is performed with the help of the four navigation keys. When the user initiates a navigation command with the help of the right and left keys (step 3.7), the ellipse formed by the five round shapes performs a rotation to the side indicated, and the group situated on the left or on the right of the central group is placed at the centre and becomes the central group (step 3.8). The navigator loops back to step 3.6. The titles of the elements of the new central group are displayed. The user can at any moment highlight a document of the central group by moving with the help of the ↑ and ↓ keys. During a rotation, the document highlighted in the central group is the first of the list. The current document is not affected by the direction commands (←, →, ↑ and ↓). If the user confirms the highlighted document with the “OK” key, this document becomes the current document (step 3.9). Upon each change of current document, the navigator loops back to step 3.2 and recalculates all the groups and in particular the four close groups appearing on the screen, this bringing about a new calculation of the identifiers of the four groups displayed.

The user will thus ride around closer and closer. When he selects a new document, he modifies his centre of interest, therefore the receiver recalculates a new work set. Advantageously, the OSD is furnished with three-dimensional functions that make it possible to give the user the impression of navigating around a space of documents, and not around a straightforward plane.

The invention is not limited to the execution of the various steps described previously following a user command. Other events such as for example the automatic waking up of the receiver, the reception of new descriptive data, or the reception of a command from the document provider to display a new graphical interface, may trigger the various steps of the process, and activate the means responsible for implementing them.

FIGS. 5.a, 5.b and 5.c show three shots obtained pursuant to navigation commands according to another embodiment. When the user initiates the navigator, the screen of FIG. 3.a is displayed. It shows a group containing three attributes, which are in the example, document sources. The user with the help of the ↓ and ↑ direction arrows will highlight one of these attributes and, with the “OK” key, select it. Following this command, the navigator will calculate the work set of documents and calculate groups reduced to one document. In the example, the user selects the source “Warner On Line”. The screen illustrated in FIG. 5.b then appears. In the left part of the screen the navigator brings into view four documents corresponding to the request based on “Warner On Line”. The document “Les Dents de la Mer” is current, its selection is performed for example in alphabetical order. In the right part of the screen, the navigator proposes other groups associated with identifiers. The identifiers of the groups proposed possess with the document at least one common characteristic.

The identifiers are in the example:

“Spielberg” (attribute corresponding to the producer of the document,

“Requins” (which is one of the significant words of the summary),

“Horror” (which is the attribute corresponding to the topic).

The user goes from one column to another with the help of the ← and → keys and rides around within a column with the help of the ↑ and ↓ keys. The user can select the current document with the “OK” key and trigger the displaying thereof by pressing the “Select” key. In the example, he wishes to continue his navigation and selects the group identified by “Requins” in the right column. FIG. 5.c then appears. The left column shows a list of documents related to the attribute previously selected. In this instance, the request is based on the presence of a certain word in the summary and/or the title.

The request having been confirmed, the titles of four documents that are in the selected group are displayed. In the example, all the four documents contain the word “Requins” in the title. The first “Les Requins, ces méconnus” is highlighted, the right column presents a list of groups related to this document. In this instance, the source: “La Chaine documentaire”, the producer “Crocodile Dundee” and the topic “wildlife documentary”. The user can with the help of the four direction keys ride from one column to the other.

An improvement consists in taking the profile of the user into account. This can be done when calculating the work set (in step 3.2). Thus, the documents that possess a certain number of attributes in common with the central document, are more often taken in the work set. As a variant, this is done when determining the close groups. For example, to determine the close documents the navigator uses the comparison of the distances between the various barycentres and the current document/point. It was stated previously that the coordinates of each point/document are calculated by assigning numerical values to the attributes of the documents. A bonus is accorded to each document for which at least one attribute corresponds to the profile of the user. Then, the proximity of a group with respect to the current document takes account of the distance with respect to the position of the central document but also to the number of bonuses that the group contains. For example, if the central point of a first group is situated 1.2 times the distance of a second group but if the first group contains three bonuses more than the second, then it is the first group that is represented in the background. Likewise, if the central point of a first group is situated 1.8 times the distance of a second group that possesses no bonuses while the first possesses nine, then it is the first group that is represented in the background. A relative distance is determined by including the number of bonuses of a group. Let d1 be the distance of a first group and d2 the distance of a second group, the relative distance of one group with respect to the other is:

$$\frac{ⅆ 1 + ( number of bonuses of group 1 / 10 )}{ⅆ 2 + ( number of bonuses of group 2 / 10 )}$$

This equation shows the predominance of the similarity of the attributes with the current document rather than the correspondence with the user profile. Such an equation prevents a group containing only documents corresponding to the profile of the user from being systematically declared close although it is not if the attributes of its documents are taken into account.

A variant use of the profile of the user consists in analyzing the user's last selections, the last twenty for example. The twenty documents or attributes selected are concatenated to form the user's profile.

Although the present invention has been described with reference to the particular embodiments illustrated, it is in no way limited by these embodiments, but is so only by the appended claims. It will be noted that changes or modifications may be made by the person skilled in the art.

1. A process for navigating among a set of multimedia documents in a receiver equipped with a display device, the multimedia documents are associated with descriptive data comprising classification elements for indexing the documents, the process is characterized in that it comprises the following consecutive steps:
a) determination of a work set among the set of multimedia documents, the documents of this work set possessing at least one characteristic in common with a current document;
b) determination of a plurality of groups among the work set, containing documents whose classification elements exhibit similarities (3.2, 3.3);
c) calculation for each group of values expressing the similarity between the classification elements of a current document chosen by the user and the classification elements of the documents contained in each group (3.4);
d) display of the elements of the current group containing the current document and of at least one identifier of another group possessing the highest similarity value calculated in step c) (3.6);
e) reception of a navigation command for changing current document (3.9) triggering a new execution of steps a), b), c) and d).

2. The navigation process as claimed in claim 1, characterized in that the number of documents in each group determined in step b) is less than a predetermined value.

3. The navigation process as claimed in claims 1 or 2, characterized in that the groups determined in step b) take into account a user profile recorded in the receiver.

4. The navigation process as claimed in claims 1 to 3, characterized in that the identifiers of the other groups displayed in step d) is a textual cue extracted from the set of data descriptive of the documents of the group.

5. The navigation process as claimed in claims 1 to 4, characterized in that a plurality of other groups is displayed in step d), the distance between the position of the identifier of each other group and the identifier of the current document is proportional to the similarity value calculated in step c).

6. The navigation process as claimed in any one of the preceding claims, characterized in that it comprises a step of correspondence between a word extracted from the descriptive data and at least one subject, said subject replacing the descriptive data in step b) of calculating the groups.

7. A multimedia receiver comprising a central unit (3), a means of receiving multimedia documents and descriptive data (5), said descriptive data containing classification elements for indexing the documents according to categories, a means of entering a user command (7, 8) for selecting a current document, characterized in that it comprises: a means (3.3) of determining a plurality of groups of documents whose classification elements exhibit similarities, a means (3.4) of calculating the values representing the similarity between the classification elements of the current document and the set of classification elements of the documents constituting each group, a means (10, 11, 3.6) of displaying a representation of the current group containing the identifiers of the documents of the group and a representation of at least one other group having the largest similarity value, a means of navigation (7, 8) making it possible to select another current document and activating the means of determination (3.3), the means of calculation (3.4), and the means of display (10, 11, 3.6) so as to bring into view groups other than previously determined on the basis of the new current document.

8. The multimedia receiver as claimed in claim 7, characterized in that it comprises a means of filtering the documents (3.2), the filtered documents possessing at least one descriptive data item in common with the current document, the means of determination (3.3) using only the filtered documents to formulate the groups.

9. The receiver as claimed in any one of claims 7 or 8, characterized in that it comprises a means of determining the identifiers of each group, these identifiers being determined on the basis of part at least of the descriptive data of the documents of the group and displayed in proximity to the representation of the corresponding groups.

10. The receiver as claimed in claim 9, characterized in that the identifiers are formed by filtering and by associating the words contained in the descriptive data of all the documents of each group.

11. The receiver as claimed in any one of claims 7 to 10, characterized in that it furthermore comprises a means of correspondence between at least one word extracted from the descriptive data and at least one subject, said subject replacing the descriptive data used by the means of calculating the groups (3.4).

12. The receiver as claimed in any one of claims 7 to 11, characterized in that it furthermore comprises a means of storing a profile of the user, the profile of the user being taken into account by the means (3.4) of calculating the values representing the similarity between the classification elements of a current document chosen by the user and the classification elements of the documents constituting each group.

13. A graphical interface for the selection and the presentation of audiovisual transmissions, characterized in that it comprises a plurality of closed and identifiable graphical shapes, each graphical shape representing a group of elements and containing a list of identifiers of elements possessing at least one common characteristic from a set of characteristics, a so-called “central” graphical shape containing a so-called “current” element, both being highlighted, the distance between each graphical shape and the central graphical shape being inversely proportional to the degree of similarity between the characteristics of the elements of the group and the characteristics of the current element.

14. The graphical interface as claimed in claim 13, characterized in that the sizes of the surface graphical shapes are proportional to the degree of similarity between the characteristics of the elements of the group and the characteristics of the current element.

15. The graphical interface as claimed in one of claims 13 or 14, characterized in that the plurality of graphical shapes constitutes an open ellipse.

16. The graphical interface as claimed in one of claims 13 to 15, characterized in that the central graphical shape exhibits the list of the identifiers of all its elements.
